(19) United States
(12) Patent Application Publication
(10) Pub. No.: US 2012/0309013 A1
(43) Pub. Date: Dec. 6, 2012

(54) Use of the Combinatorial Diversity of T-Lymphocyte Repertoire as a Prognostic Marker of Cancer

(76) Inventors: Christophe Caux, Bressolles (FR); Jean-François Mouret, Coublevie (FR); Christine Menetrier-Caux, Bressolles (FR); Nicolas Pasqual, Coublevie (FR); Thomas Bachelot, Bron (FR); Manuarii Manuel, Grenoble (FR); Jean-Yves Blay, Frontonas (FR)

(21) Appl. No.: 13/514,842

(22) PCT Filed: Dec. 9, 2010
(86) PCT No.: PCT/FR10/00829

§ 371 Date: Aug. 24, 2012

(30) Foreign Application Priority Data
Dec. 9, 2009 (EP) 09290922.5

(51) Int. Cl. G01N 21/76

(52) U.S. Cl. 435/6.12

(57) ABSTRACT

The present invention relates to a method making it possible to identify the patients, from among those affected by a given solid cancer, that have increased risk of premature death. Said method is based on the ex vivo analysis of the lymphocytic diversity of the patients on the basis of a biological sample containing lymphocytes. In fact, low lymphocytic diversity is related to a poor prognosis. Specifically, it is possible to set a diversity threshold, depending on the analysis technology used and the cancer affecting the patient, beyond which the life expectancy of the patient is significantly less than that, in general, of the patients affected by the same disease.

The present invention relates to the area of prognosis in oncology. More precisely, the present invention aims to identify, among patients with a given solid cancer, those presenting an increased risk of early death, notably so as to be able to offer them more appropriate medical care, access to therapeutic innovations and thus the hope of increasing their chances of cure or at least their length and quality of life. It also aims to identify a group at risk (probably not responding to the reference treatment) for a given tumor disease, in order to evaluate the efficacy of new therapeutic strategies and increase the benefit/risk ratio of drug candidates, thus favoring their clinical approval.

The term “solid cancers” refers to the abnormal multiplication of cells in “solid” tissues and/or organs such as the breast or the prostate, in contrast to leukemia, a cancer that affects the blood and the bone marrow.

Among solid cancers, breast cancer is one of the commonest. This is essentially a cancer that occurs in women (in France, nearly 10% of women develop breast cancer during their life). It is rare in men (less than one breast cancer in 100) but is more serious, as it is often diagnosed later. It is the commonest cancer in women and the first cause of mortality among gynecological cancers in developed countries. Although some of these cancers (10 to 15%) have a hereditary genetic origin, 85 to 90% of cases have origins that are poorly understood (so-called sporadic or non-hereditary form).

Breast cancer is a mass resulting from the multiplication of malignant cells in the mammary gland. If it is not detected and treated, this mass can grow and give rise to metastases.

A large number of treatments are available for breast cancer, depending on the stage of development and the patient's particular characteristics. Each situation must be dealt with individually and treated optimally. For localized breast cancer, the treatment has a therapeutic objective. It is based on the five therapeutic weapons of surgery, chemotherapy, radiotherapy, hormonotherapy and, more recently, immunotherapy. Surgery is the indispensable step in the therapeutic treatment of breast cancer, while the other treatments generally aim to reduce the risk of metastasis or relapse. They are therefore indicated if there is high risk and if the supposed benefit of the treatment is sufficient, as all these treatments have side effects. The expected benefit must therefore be weighed up against the risk of complication.

For metastatic breast cancer, it is rare to be able to offer a therapeutic treatment. However, modern treatments often make it possible to prolong the patient's life by several years. The treatment of metastatic breast cancer is based firstly on chemotherapy and hormonotherapy. Treatment by surgery or by radiotherapy of the metastatic sites can be envisaged with a therapeutic objective when all the sites are accessible to treatment (for example in the case of single hepatic or vertebral metastasis) or with a palliative objective (for example, irradiation of a painful bone metastasis).

New therapeutic strategies, notably based on the use of monoclonal antibodies or on stimulation of the immune system, are being evaluated and developed at a sustained pace. For example, trastuzumab (Herceptin®) targets the Her2 receptor (or CerbB2), which is a membrane receptor allowing activation of one of the routes of cellular proliferation, overexpressed in 25% of breast cancers, often of poor prognosis. Herceptin® was used at first in palliative situations. In this context, Herceptin® has made it possible, on average, to double the survival time of these patients. Added to adjuvant chemotherapy, Herceptin® in perfusion every 21 days, for 12 months, halves the risk of relapse in Her2+ patients and reduces mortality by about a third.

Despite these advances, breast cancer mortality is still high, especially when a metastatic stage is reached. There is, however, considerable individual variability, with a survival time ranging from less than a month to several years.

Several prognostic markers have been investigated for determining whether a patient with a given solid cancer has an increased risk of early death. Examples that may be mentioned are the hemoglobin level, the presence of hepatic metastases, PS (Performance Status: quantifying the patient's general condition; PS is therefore a figure representing this general condition) or the level of polynuclear neutrophils (PNN) (Ray-Coquard et al., 2009) and lymphopenia, particularly T CD4+ lymphopenia identified by the inventors of the present invention (Borg et al., 2004).

The present invention proposes a new prognostic marker of early death for patients with solid cancer, more powerful than certain markers already described, and independent of the latter. The inventors have in fact demonstrated that a decrease in the immune diversity of the T lymphocytes in the blood is correlated with an increased risk of early death.

Each functional T lymphocyte has a receptor (TCR) which specifically recognizes a limited number of different antigenic peptides. Accordingly, a vast repertoire of receptors is required for defending an individual against multiple infections, malignant proliferations or other aggressive factors that she is likely to encounter in his/her surroundings. For this purpose, the immune system has developed a mechanism of assembling a large number of segments of genes V, D, J positioned discontinuously in the genome. This assembly mechanism, called “V(D)J recombination”, is independent from one cell to another and makes it possible to obtain a single gene “fragment” coding for the TCR. This system makes it possible, with a modest number of genes, to generate a large number of different receptors. Each cell uses a combination of gene segments according to precise rules and obtains a potentially unique TCR chain.

The principle of recombination is based on recognition of specific RSS sequences of the V(D)J genes and excision of the chromosomal region intercalated between the two rearranged genes. Each V and J gene has, at one of its ends, a recombination signal sequence (RSS). As for the D genes, they possess them at both ends. The RSSs are sequences recognized by the specific recombinase enzymes, RAG I and RAG II, specifically expressed in the lymphocytes. These proteins are the principal actors of the rearrangement. Once associated with the HMG (High mobility group) proteins, the RAG enzymes recognize the RSS nonamer owing to their homeodomain and induce cleavage between the V, D, J gene segment and the heptamer, so as to generate a coding end and a signal end. A rearrangement is completed after ligation of the two coding ends V and J. This step is preceded by the action of the enzyme TdT and of a nuclease at the V-J junction. Once rearranged, the newly formed gene is transcribed and then spliced into mRNA before being translated into membrane protein.

Four main mechanisms contribute to generating the diversity of the repertoire: 1) a combinatorial diversity, which corresponds to the first step of rearrangement between a V segment and a J segment, optionally separated by a D segment; 2) a junctional diversity, generated at the junction between the rearranged gene segments; 3) somatic hypermutations in the rearranged genes V-J and V-D-J; 4) a pairing diversity of the protein heterodimers TCRα×TCRβ or TCRγ×TCRδ.

The first step in generating diversity, called “combinatorial diversity” herein, is based on the principle of rearrangement of the V(D)J genes. Calculation of this diversity consists of estimating the number of possible combinations mV×nD×pJ. This first step in the generation of diversity defines the order of magnitude of the repertoire. In fact, even if this step only generates a modest variability of combination (of the order of some thousands of possible combinations relative to the theoretical maximum repertoire estimated at 10¹⁵ (Davis and Bjorkman, 1988)), the maximum combinatorial diversity is directly linked to the number of V, D and J genes initially available: the other two steps in the generation of diversity amplify the diversity of the primary repertoire exponentially.

The junction diversity makes it possible to generate a very great variability at the level of the CDR3 region of the receptor in contact with the antigenic peptide. Two mechanisms contribute to the increase in junctional diversity: 1) the first mechanism is due to the addition of P nucleotides (P for palindromic), arising from resolution of the hairpin of the rearranged segments (Fugmann et al., 2000). The diversity generated is not as great as that resulting from the second mechanism involving the terminal enzyme deoxynucleotidyl transferase; 2) the TdT produces considerable diversity, by randomly adding nucleotides N to the 3′ end of each coding segment, without needing a genomic template (Bogue et al., 1992).

The mechanism of the secondary rearrangements helps to “conserve” diversity: junctional diversity represents the largest factor in amplification of the diversity of the repertoire, but if there had not been the mechanism of secondary rearrangement to save ⅔ of the thymocytes that have interrupted their reading frame, this benefit in terms of diversity would represent an important cost for the organism, even before the step of positive selection. These unproductive rearrangements cannot give a functional TCR protein. The cell then has the possibility of trying a second rearrangement with the V(D)J genes still available at the locus. The property of concentric opening of the TRAD locus favors this process by allowing the cell the greatest number of possible chances, since the first rearrangements effected by the cell take place between a V-J gene pair that are close together (Pasqual et al., 2002). If these first rearrangements are not productive, the cell has the possibility of trying rearrangements on its second chromosome, or to use the V and J genes available on either side of the first rearrangement. Thus, the secondary rearrangements allow a large number of cells to survive which, after a first unproductive rearrangement, ought to have been eliminated.

Somatic hypermutations (SHMs) occur during differentiation of the B lymphocytes in the lymph nodes, on encountering an antigen. The SHMs are situated in “hot spot motifs” of V-J and V(D)J rearranged genes of the Igs (Chaudhuri et al., 2003) but also, in certain cases, in V-J and V(D)J rearranged genes of the TCRs (Kotani et al., 2005). The TCR can be the target of SHM at the level of the variable genes, if the lymphocyte overexpresses the enzyme AID (activation-induced cytidine deaminase) which is normally specific to the B lymphocytes. Normally the TCR does not undergo SHM because the T lymphocyte quite simply does not synthesize AID. Nevertheless, if the T lymphocyte starts expressing it, the TCR is as sensitive to this enzyme as the BCR as it possesses all the sequences on which it acts. Overall, it is described in the literature that this mechanism induces a supplementary diversity by a factor of 1000 with the aim of increasing the chances of recognizing an antigen.

The diversity arising from pairing between a TCRα chain and a TCRβ chain is estimated by multiplying the number of different combinations of a TCRα chain by the number of possible combinations for the TCRβ chain. The diversity generated by this mechanism is directly dependent on the number of primary combinations obtained in the rearrangement. In fact, if we examine the number of primary combinations TCRγδ in the mouse, without taking the junctional diversity into account, the result is only 40 TCRδ (=10V*2D*2J)×28 TCRγ (=7V*4J)=1120 different combinations, whereas the same calculation leads to 5.6 10⁶ combinations for TCRαβ (calculated as follows: 102Vα*60Jα*33Vβ*2Dβ*14Jβ).

The diversity of the repertoire of the immunoglobulins produced by the B lymphocytes results from the same mechanisms as those described above for the T lymphocytes.

Measurement of the immunological diversity makes it possible, among other things, to investigate the mechanisms for setting up the immune repertoire, homeostasis, the T or B lymphocytes involved in an immune response, in a leukemia or to evaluate the immunodeficiency induced by a treatment or a disease, in particular tumoral, or conversely the specific activation of the immune system. This list is not exhaustive.

Investigation of the immune repertoire of a lymphocyte population has led to the development of several multiparametric approaches, making it possible both to measure the level of diversity and identify the presence of certain specific T or B clones. Certain approaches elaborated by immunologists for evaluating these various levels of diversity are listed below according to the principle and the “level” of measured diversity.

### Measurement of Diversity V

By cytometry (Van den Beemd, van Dongen et al. 2000)
By Q-PCR at the level of the genome and transcriptome (Fuschiotti et al., 2007; Pasqual et al., 2002).
By sequencing

### Measurement of CDR3 Junctional Diversity:

By Immunoscope® (Cochet et al., 1992; Pannetier et al., 1995).
Q-PCR coupled to the immunoscope (TcLandscape®)
By sequencing
By the Amplicot method at the genomic level (Baum and McCune, 2006).
By DNA chip (Bonarius et al., 2006).

### Investigation of Somatic Hypermutations (SHMs):

PCR/sequencing (Hamblin et al., 1999).

### Indirect Measurement Via the Decrease in Excision Circles TRECs

By PCR (Douek et al., 1998).
By Q-PCR (Pham et al., 2003).

Although some of these approaches have proved their worth in basic research, notably the Immunoscope® (Pannetier, C., J. Even, et al., 1995) or flow cytometry (Van den Beemd, van Dongen et al., 2000), a certain number of scientific and technical validations are still required for evaluating the relevance of their use as medical biomarkers. In view of the complexity of the immune system, the scientist would need to couple additional technological approaches for decoding all of the information contained in the immune repertoire and relevant to a given pathology.

Other methods, based on the use of PCR specifically amplifying nucleic acid segments characteristic of certain rearrangements, have been described. For example, U.S. Pat. No. 5,296,351 and U.S. Pat. No. 5,418,134 present a method of detecting lymphoid leukemias or B or T lymphomas, based on amplifications of sequences coding for immunoglobulins and/or T receptors, using “consensus” primers for amplifying several V-J rearrangements simultaneously.

The inventors have previously described methods and kits for measuring the combinatorial diversity of the repertoire of the T and/or B lymphocytes of an individual (WO 2009/095567). In this patent application, the inventors also defined “divpenia” as a deficiency of combinatorial immune diversity, and mentioned the increased risk of mortality by infection for patients in a state of divpenia.

In the present text, divpenia denotes a deficiency of immune diversity, regardless of the level (combinatorial diversity, junctional diversity or other) at which this diversity is measured. T divpenia therefore denotes a deficiency of diversity of the T-lymphocyte repertoire.

In the studies presented below in the experimental section, the inventors tried to determine whether a relation exists between divpenia and various risks to be taken into account when treating patients who have solid cancers, notably at the metastatic stage. Surprisingly, they found that T divpenia had a strong, direct correlation with early mortality (not necessarily by infection), especially in the case of metastatic breast cancer (example 1). It is important to note that T divpenia is not systematically correlated with other known markers of early mortality, and in particular lymphopenia. In particular, the inventors determined, in the case of metastatic breast cancer, that a combinatorial diversity of the V(D)J rearrangements of the genes of the hTRB locus less than 20% of the possible rearrangements is a powerful prognostic factor of early death, with a median survival of less than 6 months. This does not seem to be the case with B divpenia (example 2). Moreover, contrary to expectation, divpenia (T or B) does not seem be a risk factor of severe toxicity of the chemotherapeutic treatments used for treating primary breast cancer (results not shown).

The rapid identification, before any treatment, of patients having an increased risk of early mortality has important consequences for these patients and for medical research, as it means that particular monitoring can be envisaged for these patients, if necessary with longer hospitalization and/or the administration of treatments that are less immunosuppressive or are more targeted on stimulation of their immune system. For medical research, it makes it possible to identify a homogeneous population of patients for whom the reference treatment will probably be ineffective and for whom the clinicians currently seem particularly powerless. The characterization of such a population represents a major challenge for the clinicians and the pharmaceutical industries for clinical trials of innovative treatments that will have a higher efficacy than the reference treatments, thus increasing the possibility of registration of new medicinal products. This population can preferably be selected for conducting clinical trials for testing innovative treatments.

The present invention therefore relates firstly to the use of the diversity of an individual's T-lymphocyte repertoire who has a metastatic solid cancer, as a prognostic marker of the development of this cancer. In particular, in the case of T divpenia, this marker is indicative of an increased risk of early death.

More particularly, the present invention relates to a method for determining ex vivo or in vitro whether a patient with a solid cancer has an increased risk of early death, in other words for establishing ex vivo or in vitro a prognosis for an individual who has a metastatic solid cancer, comprising the following steps:

(i) on the basis of nucleic acid (for example, genomic DNA or messenger RNA) obtained from a biological sample containing lymphocytes of said individual, measuring the level of diversity of the T-lymphocyte repertoire of said individual;
(ii) comparing the level of diversity measured in step (i) with a predetermined threshold;
(iii) deducing from that, in the case when the level of diversity measured in step (i) is below the predetermined threshold, that the individual has a high risk of early death.

A particular example of solid cancer for which this method is appropriate is breast cancer in the metastatic phase, but based on the inventors' previous work on lymphopenia (Borg et al., 2004; Ray-Coquard et al., 2009) it can also be transposed to all solid cancers, such as cancers of the prostate, lung, colon, ovary, the ORL sphere, lymphomas, sarcomas, etc., when they become metastatic.

Quite clearly, the threshold considered in step (ii) may depend on the patient's clinical profile (type and stage of cancer, and if applicable, age and other physiological parameters), and a person skilled in the art is able to conduct the necessary experiments, by retrospective or prospective studies, to define a relevant threshold for a given type of pathology and/or patient.

Moreover, the concept of “early mortality” is to be referred to the individual's type of cancer, as well as the stage of progression of this cancer (notably, to know whether or not it is metastatic). The term “increased (or high) risk of early mortality” will be used for a patient when she belongs, in a cohort representative of his/her pathological state, to a subpopulation whose median survival is less than that of the whole cohort (an example of a cohort representative of patients with metastatic breast cancer is given in the experimental section). For a given subpopulation (for example, patients in a state of T divpenia), the term early mortality will be used when the median survival of this subpopulation (representative of the life expectancy of the members of this subpopulation) is statistically significantly less than that of the whole cohort. In the context of the present invention, early mortality of patients in a state of T divpenia typically corresponds to a life expectancy two or three times lower, or even 5 times lower than that of a population of patients with the same cancer at the same stage, without taking into account their level of immune diversity (or, a fortiori, than that of a population of patients with the same cancer at the same stage, but having a satisfactory lymphocyte diversity). Thus, an individual having an increased risk of early death has a life expectancy significantly lower (typically half) than she would have with the same medical and biological assessment (type and stage of cancer, PS, hemoglobin level etc.), without taking into account his/her lymphocyte diversity T, or whether the latter was above a specified threshold (for example, above 40%).

Another parameter that may affect the threshold of T-lymphocyte diversity, below which T divpenia constitutes a significant marker of risk of early mortality, is the technology with which this diversity is measured. In fact, as mentioned above, a person skilled in the art has a large number of technologies at his disposal (sequencing, immunoscope, DNA chip, etc.) for measuring, at various levels, the diversity of an individual's T-lymphocyte repertoire. The present invention can be applied using any technology that measures the T-lymphocyte diversity, regardless of the material from which it is derived (gDNA, RNA, etc.) and the level at which this diversity is measured (combinatorial diversity, junctional diversity, etc.). The transposition of the results described below in the experimental section, by experiments and a routine statistical analysis, will allow a significant threshold to be determined for the alternative technology used.

According to a particular embodiment of the invention, illustrated experimentally below, the diversity is measured at the combinatorial level. In the patent application published under number WO 2009/095567, the inventors described several methods for measuring the combinatorial diversity, depending on the locus or loci targeted (TRA, TRB, TRG, TRD), whether or not incomplete rearrangements are analyzed, the percentage, for each locus, of rearrangements analyzed (carrying out a varying number of PCRs), the level of analysis of these rearrangements (detection of the percentage of rearrangements or quantification of each rearrangement observed and precisely identified), etc.

In the context of the experimental study presented below, the combinatorial diversity of the T-lymphocyte repertoire was evaluated on the basis of analysis of the V(D)J rearrangements of just the one locus TRB, by a method allowing more than 80% of the V(D)J rearrangements of the TRB locus to be analyzed. Moreover, a method in which the technology used in step (i) makes it possible to analyze at least 70% of the V(D)J rearrangements of the TRB locus constitutes a preferred embodiment of the invention. In particular, the method of the invention can be applied advantageously by measuring the combinatorial diversity of the T-lymphocyte repertoire by multi-n-plex PCRs with n≧2 using combinations of at least 3 primers, each combination of primers comprising at least the primers hTRBJ1.6 (CTTGGTGCATGGCTATGTAATCCTG, SEQ ID No: 1), hTRBJ2.7 (CTCGCCCTCTGCTCAGCTTTCC, SEQ ID No: 2) and a primer hTRBV selected from the group consisting of primers of SEQ ID Nos.: 3 to 25. A method according to the invention, in which the TRB locus is analyzed by carrying out at least 23 multi-2-plex PCRs, each multi-2-plex PCR being carried out with a triplet of primers consisting of the primers hTRBJ1.6 (SEQ ID No: 1), hTRBJ2.7 (SEQ ID No: 2) and a primer hTRBV selected from the group consisting of the primers of SEQ ID Nos.: 3 to 25 (Table 1), constitutes a preferred embodiment of the invention.

TABLE 1
primers hybridizing to the TRB locus (genes V),
useble in the context of the present invention

| | | | Distance between | | |
|---|---|---|---|---|---|
| | | | the 5′ end of the | | |
| Name of | Name | Size | primer and the end | | SEQ ID |
| the gene | of the primer | (nt) | of the gene V (pb) | Sequence | No. |
| TRBV2 | hTRBV2up2 | 26 | 255 | CACACAGATGGGAC | 3 |
| | | | | AGGAAGTGATCT | |
| TRBV4 | hTRBV4up_ex | 23 | 100 | GCTTCTCACCTGAAT | 4 |
| | | | | GCCCCAAC | |
| TRBV5.1, 3, | hTRBV5up_ex1/2 | 25 | 256 | CTGATCAAAACGAG | 5 |
| 4, 5, 6, 8 | | | | AGGACAGCAAG | |
| TRBV5.7 | hTRBV5up_ex2/2 | 25 | 256 | CTGATCAAAACGAG | 6 |
| | | | | AGGACAGCACG | |
| TRBV6.4 | hTRBV6up_ex2/2 | 23 | 279 | GATCACCCAGGCAC | 7 |
| | | | | CAACATCTC | |
| TRBV7.2 | hTRBV7up_ex2/3 | 25 | 301 | CAGATCACACAGGA | 8 |
| | | | | GCTGGAGTCTC | |
| TRBV7.9 | hTRBV7up_ex3/3 | 27 | 303 | CACAGATCACGCAG | 9 |
| | | | | ATACTGGAGTCTC | |
| TRBV9 | hTRBV9up_ex | 23 | 92 | CGCACAACAGTTCCC | 10 |
| | | | | TGACTTGC | |
| TRBV11 | hTRBV11up_ex | 27 | 120 | TTCACAGTTGCCTAA | 11 |
| | | | | GGATCGATTTTC | |
| TRBV12.1 | hTRBV12.1up1 | 27 | 196 | TTCTCTGGTACAGAC | 12 |
| | | | | AGACCTTTGTGC | |
| TRBV12.2 | hTRBV12.2up1 | 27 | 196 | TTTTCTGGTACAGAG | 13 |
| | | | | ATACCTTCGTGC | |
| TRBV13 | hTRBV13up1 | 25 | 356 | GTTGCTGAAGTGTCA | 14 |
| | | | | AACTCTCCCG | |
| TRBV14 | hTRBV14up_ex | 24 | 271 | TCCCCAGCCACAGC | 15 |
| | | | | GTAATAGAGA | |
| TRBV15 | hTRBV15up_ex | 24 | 163 | CCCCAAAGCTGCTGT | 16 |
| | | | | TCCACTACT | |
| TRBV16 | hTRBV16up1 | 22 | 295 | CTCCTGGTGAAGAA | 17 |
| | | | | GTCGCCCA | |
| TRBV18 | hTRBV18up1 | 22 | 46 | TAGTGCGAGGAGAT | 18 |
| | | | | TCGGCAGC | |
| TRBV19 | hTRBV19 up 2 | 24 | 217 | CTGGGAGCAAGTGA | 19 |
| | | | | GTCCTGGGT | |
| TRBV20 | hTRBV20-1up_ex | 24 | 91 | TCATCAACCATGCAA | 20 |
| | | | | GCCTGACCT | |
| TRBV24 | hTRBV24up_ex | 24 | 96 | AGTGTCTCTCGACAG | 21 |
| | | | | GCACAGGCT | |
| TRBV25 | hTRBV25up_int | 23 | 273 | CCTCTTTGTTGGGTT | 22 |
| | | | | TGTGCCTG | |
| TRBV27 | hTRBV27up2 | 22 | 312 | GTCCCCTTCCTTTAC | 23 |
| | | | | AGGCCCC | |
| TRBV29 | hTRBV29up_G | 21 | 91 | CCATCAGCCGCCCA | 24 |
| | | | | AACCTAA | |
| TRBV30 | hTRBV30up1 | 26 | 148 | TGCTCTTCTACTCCG | 25 |
| | | | | TTGGTATTGGC | |

If necessary, a person skilled in the art can choose to evaluate the combinatorial diversity of the T-lymphocyte repertoire by examining a more limited number of V(D)J rearrangements of the TRB locus, and/or by examining rearrangements of another locus selected from the loci TRA, TR and TRD. The percentage diversity of the patient's T repertoire will then be extrapolated, by calculating the percentage of rearrangements observed among the rearrangements theoretically observable with the technology used. Of course, the result obtained will be all the more informative if the technology used permits theoretical observation of a large number of rearrangements. The cost of the analysis will therefore be weighed against the desired level of information, depending on circumstances, to determine an optimum number of observable rearrangements. In any case, it is preferable, in order to obtain a usable result, to analyze at least 10 rearrangements, preferably at least 20, or 30, or even 50 rearrangements of the TRA locus or of the TRB locus. Even more preferably, a technology will be used that makes it possible to observe at least 20% of the possible theoretical rearrangements of one of these loci (299 V-J rearrangements for the TRB locus and 2500 for the TRA locus).

Example 5 below presents an alternative technology to the technology used in the other examples for measuring the diversity of the T-lymphocyte repertoire. In this example, the molecular diversity (combining the combinatorial diversity and the CDR3 diversity) is measured by high-throughput DNA sequencing of PBMC, according to the technique described by Robins et al. (Robins et al., 2009). This example shows that the diversity of the immune repertoire can be measured by various technologies, in particular by sequencing; the diversity of the immune repertoire remains, regardless of the technology used for measuring it, a prognostic marker for solid cancers (provided this measurement is sufficiently quantitative and qualitative).

For carrying out the invention, the genomic DNA is preferably purified. However, a person skilled in the art can, depending on technological developments, choose to work on crude samples. Any biological sample that may contain T lymphocytes can be used; as nonlimiting examples of samples that can be used, we may mention samples of blood (whole blood or PBMC for example), thymus, lymph node, spleen, breast, liver, skin, or more generally any tumor sample, as well as a biological fluid such as a pleural effusion or ascites.

According to a preferred implementation of the invention, the threshold of immune diversity, with which the diversity of a patient with metastatic cancer will be compared, will be predetermined in such a way that the expected survival of a patient whose level of diversity is below this threshold is at least two times lower than the expected survival generally observed for patients with the same metastatic solid cancer as that affecting this patient.

According to a particular implementation of the invention, illustrated in example 1 for a cohort of patients with metastatic breast cancer, the threshold considered in step (ii) of the method is fixed at 33% or at 30% diversity, and the interpretation in step (iii) consists of saying that if the measured level of T-lymphocyte combinatorial diversity is below this threshold, the individual has a life expectancy half that generally observed for his/her disease. Quite clearly, the reservations stated above remain relevant, and a person skilled in the art can, for a different type or stage of cancer, and/or using a different technology for analyzing the combinatorial diversity of the rearrangements of the TRB locus, adjust the threshold, so as to obtain a diversity threshold below which the life expectancy of the patients is half that for patients with the same pathology, regardless of their immunological status.

According to another particular implementation of the invention, also illustrated in example 1, the threshold considered in step (ii) of the method is fixed at 25% or at 20% diversity, and the interpretation in step (iii) consists of saying that if the measured level of T-lymphocyte combinatorial diversity is below this threshold, the individual has a life expectancy five times less than that generally observed for his/her pathology. The invention relates more specifically to a method as described above, in which the patient has metastatic breast cancer, and in which a level of diversity (in particular, of combinatorial diversity) of the V(D)J rearrangements of the TRB locus below 20-25% is indicative of an expected survival of the patient of less than 6 months (p=2.10⁻⁷).

It is particularly interesting to note that the marker according to the present invention is independent of the other risk factors identified to date (p=0.0092). Consequently, the method according to the invention can be employed for establishing a prognosis without taking these markers into account, in particular without taking the patient's lymphocyte count into consideration. However, T divpenia can, in accordance with the invention, be combined with other immune parameters such as the serum cytokine level, in particular of type IL7 or IL15, or the CD4+ cell count, or with other biological or clinical parameters such as age, performance status, lymphocyte count, CD4+ cell count or hemoglobin level, for establishing a prognosis for a patient with a solid cancer. As illustrated in example 4 below, the combination of lymphocyte count and diversity makes it possible to segregate the patients much more precisely than the use of just one of these markers. It makes it possible to identify a subpopulation that is particularly at risk (zone 1 of the LDC graph, called “lymphodivpenia”, to signify that the individuals have a low lymphocyte count, and in addition have insufficient diversity).

Another aspect of the present invention is to select patients at risk to include them in innovative clinical protocols having the objectives either of correcting lymphopenia and/or divpenia (cytokines of type IL2, IL7, IL15, immunostimulation, dietary supplements, etc.) or of evaluating emerging therapies. The possibility of identifying patients at risk before any treatment of the metastatic phase in particular is also likely to greatly increase the chances of benefiting from the treatment relative to the risk, and therefore of validating an innovative therapy relative to the reference therapy. In certain cases, this approach of stratification of patients permits a parallel reduction in cost of the clinical study, by only treating patients at risk (an example of cost comparison is given in example 3 below, purely as a guide).

The invention therefore relates to a method for determining ex vivo or in vitro whether a patient with a solid cancer should be included in a protocol of clinical research for testing a new medicinal product, comprising the following steps:

(i) determining, employing a method of prognosis as described above, whether the patient has an increased risk of early death, and
(ii) if the patient has an increased risk of early death, including him/her in the protocol of clinical research.

Identification, by a method as described above, of patients who are particularly at risk, and will probably not respond well to a conventional or reference therapy, also makes it possible to adapt the treatment of these patients, for example to offer them special hospital after-care, prophylactic antibiotic therapy, immunostimulation with drugs or with dietary supplements, therapeutic vaccination, suitable chemotherapy, preferably the least immunosuppressive as possible, or a change in dosage or frequency of administration of chemotherapy that they are already receiving.

Besides the foregoing provisions, the invention further comprises other provisions, which will become clear from the experimental examples given below, and the appended drawings.

### FIGURE CAPTIONS

FIG. 1: Survival curves of patients according to their hTRVJ diversity. Overall survival with a TCR combinatorial diversity threshold of A) 20% (p=2.10⁻⁷); B) 30% (p=0.0047); C) 33%; D) 40% (p=0.481).

FIG. 2: Overall survival as a function of the circulating CD4+ T lymphocyte count (in thick gray, patients with CD4+>450/μl and in black CD4+≦450/μl) (p=0.011).

FIG. 3: ROC curves for determining patients at risk of early death (≦12 months) in the WP1a cohort using A) divpenia or B) lymphopenia as marker.

FIG. 4: Investigation of the WP1a cohort. A) LDC graph; B) Analysis of survival according to Kaplan Meyer, comparing the patients of zone LDC1 with the patients of the other three zones; C) Analysis of survival according to Kaplan Meyer as a function of their lymphopenic state or not (threshold at 0.7 Giga/l).

FIG. 5: Investigation of the WP1b cohort. A) LDC graph; B) Analysis of survival according to Kaplan Meyer comparing patients of zone LDC1 with the patients of the other three zones.

FIG. 6: Schematic of the technology used in example 5.

FIG. 7: 3D representation of the diversity of a sample of PBMC from a healthy subject, measured A) and B) by sequencing, and C) by multi-N-plex PCRs.

FIG. 8: 3D representation of the diversity of a sample of PBMC from a T leukemic subject, measured A) and B) by sequencing, and C) by multi-N-plex PCRs.

### EXAMPLES

### Example 1

### Investigation of the Correlation Between Increased Risk of Early Death and Low Combinatorial T Diversity, in Patients with Metastatic Breast Cancer

### Materials and Methods

### Selection of the Patients

Patients included in the SEMTOF clinical protocol conducted at the CLB (Centre Léon Bérard): patients with breast cancer in metastatic phase in first-line chemotherapy whose PS (Performance Status) is less than or equal to 2. The patients included have received the chemotherapy treatments used conventionally in this pathology. The blood sample on which analysis of the immune repertoire will be carried out is taken before administration of the first line of chemotherapy.

### Measurement of Combinatorial Diversity T

A Multiplex PCR ImmunTraCkeR®P is performed using an “upstream” oligonucleotide specific to all the members of a given family V and a “downstream” oligonucleotide specific to a given family J. This technology permits simultaneous detection of several V-J rearrangements in the same reaction. The ImmunTraCkeR®β assay is composed of 23 wells (+1 well for internal quality control), each capable of detecting all of the rearrangements of a family V. This assay makes it possible to detect 276 different hTRB V-J rearrangements (276 rearrangements observed would therefore correspond here to 100% of the observable rearrangements). Similarly, it is possible to detect the 48 possible hIgH V-J rearrangements, providing complete coverage of this repertoire. The PCR conditions have been described previously (Marodon et al., 2009).

The semi-quantitative and qualitative determination of the repertoire is described below.

Attribution of the rearrangements: this attribution consists of comparing the measured size of the PCR products with a standard for which the size and concentration of each product are known. This analysis is either performed manually or with the Constel'ID software developed by ImmunID.

Semiquantitative evaluation: The PCR is stopped at the end of the exponential phase of amplification. The signal is measured as a function of the intensity of fluorescence of our marker by a CCD camera of the DNA chip type. Quantification of the digital signal is provided by acquisition software which measures the intensity of fluorescence of the V-J rearrangements detected, normalized relative to the migration standard.

Qualitative evaluation of the immune repertoire: a repertoire diversity score is calculated as a function of the maximum number of rearrangements expected (number of V(D)J rearrangements present in the sample, divided by the number of rearrangements theoretically observable with the ImmunTraCkeR kit (in this case, 276), multiplied by 100). These data make it possible to evaluate the qualitative aspect of the immune repertoire and estimate the level of disturbance of the repertoire following a treatment.

### Statistical Analyses

In order to determine the role of the various cancer biomarkers in patient survival, a model for estimation of overall survival was constructed. The type of statistical model used for this is the Cox model. The model is constructed on the basis of bringing together various prognostic factors already identified that can be protective or with risk of death from the cancer (e.g.: a low hemoglobin concentration is at risk for the patient). The predictive value of each of these various factors is evaluated beforehand individually (univariate analysis), in order to determine the relevance of their integration in a multifactorial model (multivariate analysis) of prediction of overall survival. This preliminary evaluation is also performed by application of a Cox model.

### Kaplan-Meier Curve

The Kaplan-Meier method makes it possible to estimate the probability of survival with its confidence interval at 95% for censored data on the right and to plot survival curves (Kaplan and Meier, 1958; Rothman, 1978). The time intervals begin at the instant t when a death occurs and end just before the next death.

### Cox Model

The Cox model takes into account the effect of confounding factors explaining survival by a so-called multivariate analysis (Cox, 1972; Therneau and Grambsch, 2000). The effect of a variable on survival is modelled after adjustment for the other variables explaining deaths introduced in the model.

Overall survival: the overall survival was defined as the date of entry into the protocol until the patient's death or the date of last news for patients still alive at the last contact.

### Results

Investigation of the TCR combinatorial diversity at the moment of relapse in patients with breast cancer makes it possible to predict the risk of early death (<6 months) and thus identify a subgroup of patients probably refractory to the reference treatment and therefore eligible for access to therapeutic innovations in the context of clinical trials.

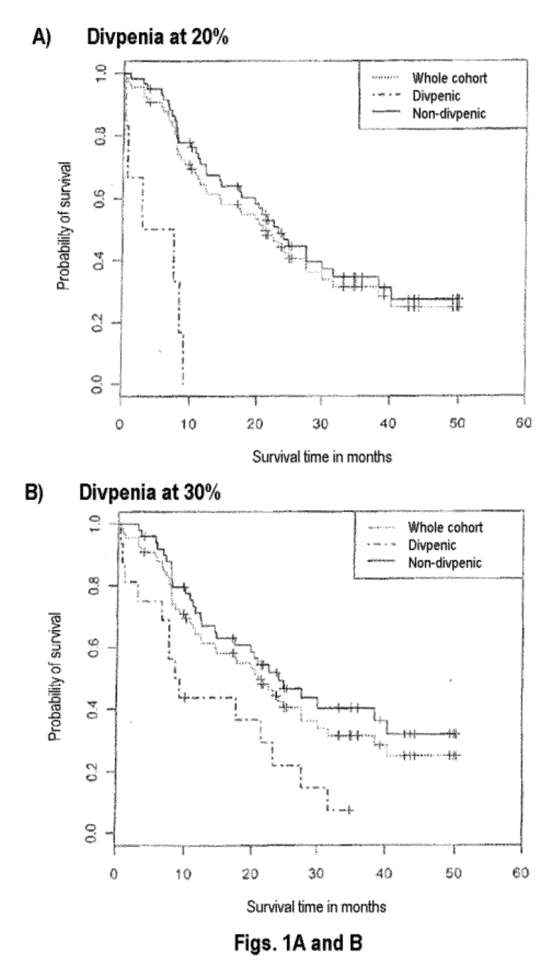

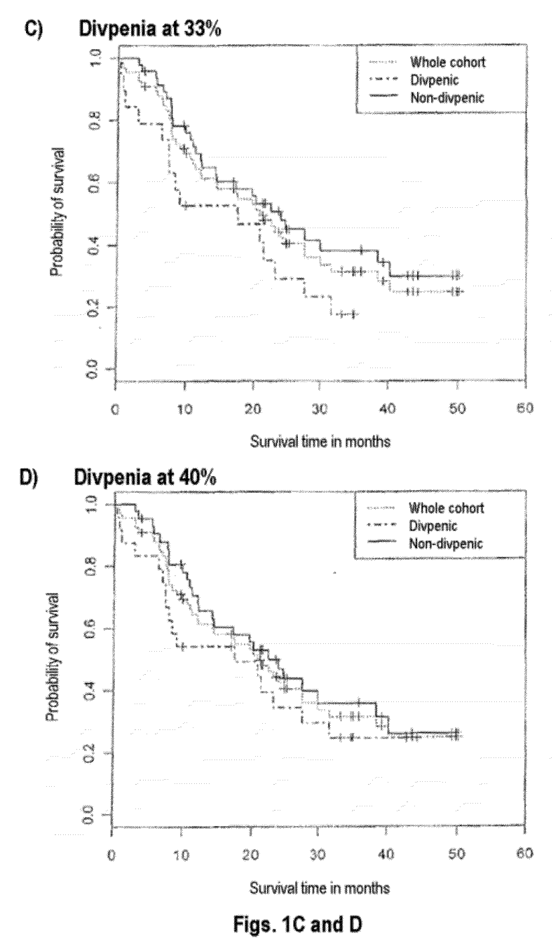

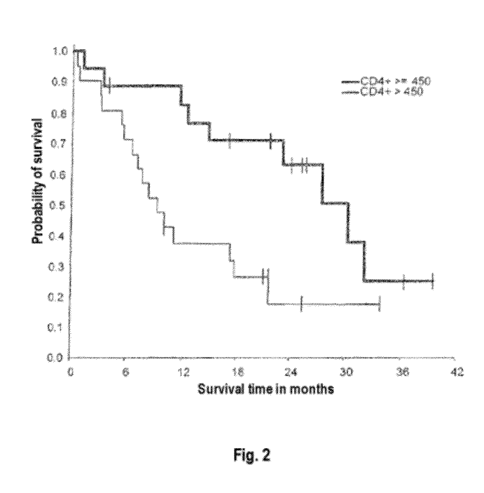

A univariate statistical study performed on a cohort of 66 patients showed that a combinatorial diversity of the β chain of the TCR <20% is a marker of risk of early death (FIG. 1-C). This marker is significant starting from the diversity threshold of 30% (FIG. 1B) and is optimal at 20% (FIG. 1C). 6/6 patients with diversity <20% died, with a median survival of 5.21 months vs. 37/60 deaths for the patients with diversity >20% with a median survival of 23.2 months.

A multivariate analysis confirms the results observed in univariate when divpenia is integrated in a validated simple prediction model (Table 2). A combinatorial diversity hTRB <20% is an independent factor (p-value <0.05) of the other prognostic factors such as the hemoglobin level, the level of PNN and the hepatic localization of the metastases. Note that lymphopenia (LT<700/μl) did not appear as a prognostic factor of early death in the entire cohort studied (P=0.35).

TABLE 2
multivariate analysis of combinatorial diversity TRB threshold 20%
(qualitative value) as a function of overall survival
(HR: Hazard Ratio; SD: Standard Deviation)

| | | Survival rate | | | | IC lower | IC upper |
|---|---|---|---|---|---|---|---|
| FACTORS | Groups. | at 9 months | HR | SD | P | 95% | 95% |
| Hemoglobin (g/dL) | <11.5 | 44% | 3.285 | 0.369 | 1.3 × 10⁻³ | 1.592 | 6.776 |
| | >=11.5 | 78% | | | | | |
| PNN (Giga/L) | <=7.5 | 70% | 1.821 | 0.567 | 0.290 | 0.599 | 5.531 |
| | >7.5 | 57% | | | | | |
| Tumor site meta | No | [82%; 88%] | 0.338 | 0.450 | 0.016 | 0.140 | 0.817 |
| hepatic | Yes | 64% | | | | | |
| DIVPENIA.TRB.VJ | <20% | 17% | 4.743 | 0.598 | 0.009 | 1.470 | 15.301 |
| | >=20% | 78% | | | | | |

It is commonly assumed that measurement of the PNN count is one of the markers of risk of patients with cancers or other infectious disorders.

CD4+ lymphopenia described as a marker of early death (Borg et al., 2004) indicates that the immune system, and more particularly the T lymphocytes, can be of interest in the prognosis of early death. Now, really interestingly, multivariate statistical analysis with evaluation of the survival rate at 9 months as the frame of reference indicates that TRB divpenia <20% is a more powerful prognostic factor than measurement of the PNNs and of the presence of hepatic metastases. Moreover, the inventors' observations showed that measurement of TRB divpenia is a factor that is independent of the measurement of CD4+ lymphopenia (p-value <0.05) (Tables 3 & 4).

TABLE 3
multivariate analysis of the TRB combinatorial diversity (threshold 30%)
versus CD4 count (threshold 450 cells/μL) (qualitative value) as a function
of overall survival.

| | | Survival rate at | | | | IC lower | IC upper |
|---|---|---|---|---|---|---|---|
| FACTOR | Groups. | 14 months | HR | SD | P | 95% | 95% |
| CD4+ | <=0.450 | 28% | 2.503 | 0.461 | 4.7 × 10⁻² | 1.014 | 6.183 |
| | >0.450 | 71% | | | | | |
| DIVPENIA_TRB_VJ | <30% | 36% | 2.232 | 0.431 | 6.3 × 10⁻² | 0.959 | 5.198 |
| | >=30% | 61% | | | | | |

TABLE 4
multivariate analysis of TRB combinatorial diversity (threshold 20%) versus CD4 count
(threshold 450 cells/μL) (qualitative value) as a function of overall survival

| | | Survival rate | | | | IC lower | IC upper |
|---|---|---|---|---|---|---|---|
| FACTOR | Groups. | at 9 months | HR | SD | P | 95% | 95% |
| CD4+ | <=0.450 | 45% | 2.489 | 0.461 | 0.048 | 1.008 | 6.148 |
| | >0.450 | [83%; 88%] | | | | | |
| DIVPENIA_TRB VJ | <20% | 17% | 5.188 | 0.597 | 0.006 | 1.611 | 16.709 |
| | >=20% | 78% | | | | | |

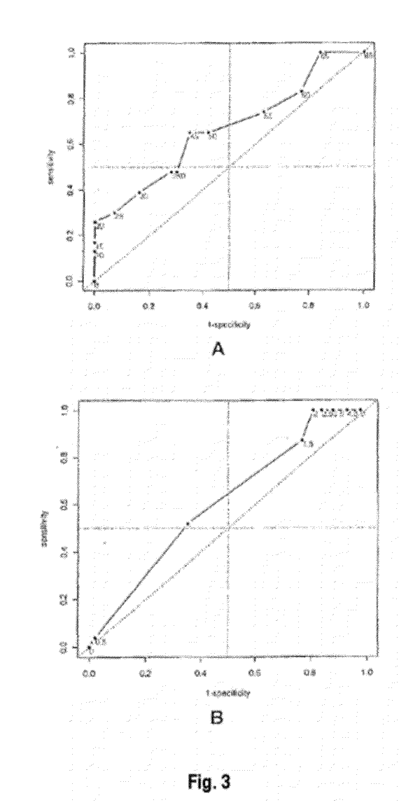

FIG. 3 shows the ROC (Receiver Operating Characteristic) curves for the cohort studied in this example, differentiating patients who died before and after 12 months, as a function of lymphocyte diversity (curve 3A) or of the lymphocyte count (curve 3B).

TABLE 5
data for constructing the ROC curve as a
function of divpenia

| Thresholds | VP | VN | FP | FN | Se | Sp | 1 − Sp |
|---|---|---|---|---|---|---|---|
| 0 | 0 | 43 | 0 | 23 | 0 | 1 | 0 |
| 5 | 0 | 43 | 0 | 23 | 0 | 1 | 0 |
| 10 | 3 | 43 | 0 | 20 | 0.13 | 1 | 0 |
| 15 | 4 | 43 | 0 | 19 | 0.17 | 1 | 0 |
| 20 | 6 | 43 | 0 | 17 | 0.26 | 1 | 0 |
| 25 | 7 | 40 | 3 | 16 | 0.3 | 0.93 | 0.07 |
| 30 | 9 | 36 | 7 | 14 | 0.39 | 0.84 | 0.16 |
| 35 | 11 | 31 | 12 | 12 | 0.48 | 0.72 | 0.28 |
| 40 | 11 | 30 | 13 | 12 | 0.48 | 0.7 | 0.3 |
| 45 | 15 | 28 | 15 | 8 | 0.65 | 0.65 | 0.35 |
| 50 | 15 | 25 | 18 | 8 | 0.65 | 0.58 | 0.42 |
| 55 | 17 | 16 | 27 | 6 | 0.74 | 0.37 | 0.63 |
| 60 | 19 | 10 | 33 | 4 | 0.83 | 0.23 | 0.77 |
| 65 | 23 | 7 | 36 | 0 | 1 | 0.16 | 0.84 |
| 70 | 23 | 0 | 43 | 0 | 1 | 0 | 1 |
| 75 | 23 | 0 | 43 | 0 | 1 | 0 | 1 |
| 80 | 23 | 0 | 43 | 0 | 1 | 0 | 1 |

TABLE 6
data for constructing the ROC curve as a
of lymphopenia

| thresholds | VP | VN | FP | FN | Se | Sp | 1 − Sp |
|---|---|---|---|---|---|---|---|
| 0 | 0 | 43 | 0 | 23 | 0 | 1 | 0 |
| 0.5 | 1 | 42 | 1 | 22 | 0.04 | 0.98 | 0.02 |
| 1 | 12 | 28 | 15 | 11 | 0.52 | 0.65 | 0.35 |
| 1.5 | 20 | 10 | 33 | 3 | 0.87 | 0.23 | 0.77 |
| 2 | 23 | 8 | 35 | 0 | 1 | 0.19 | 0.81 |
| 2.5 | 23 | 7 | 36 | 0 | 1 | 0.16 | 0.84 |
| 3 | 23 | 5 | 38 | 0 | 1 | 0.12 | 0.88 |
| 3.5 | 23 | 5 | 38 | 0 | 1 | 0.12 | 0.88 |
| 4 | 23 | 3 | 40 | 0 | 1 | 0.07 | 0.93 |
| 4.5 | 23 | 3 | 40 | 0 | 1 | 0.07 | 0.93 |
| 5 | 23 | 1 | 42 | 0 | 1 | 0.02 | 0.98 |

The area under the curve (AUC) is 0.67 for divpenia and 0.63 for lymphopenia, which confirms that divpenia is a more powerful risk factor than lymphopenia.

### Conclusion

The ImmunTraCkeR β kit makes it possible to predict the risks of early death in patients with breast cancer in metastasis. This marker is independent of CD4+ lymphopenia (<450 CD4+/μl) described by Borg C et al. (2004).

### Example 2

### Investigation of the Correlation Between Increased Risk of Early Death and Low Combinatorial Diversity B, in Patients with Metastatic Breast Cancer

### Materials and Methods

The combinatorial diversity of the B lymphocytes was studied using the hIgH® assay.

A Multiplex PCR IgH® is performed using an “upstream” oligonucleotide specific to all the members of a given family V and a “downstream” oligonucleotide specific to a given family J. This technology permits simultaneous detection of several V-J rearrangements in the same reaction. The IgH® assay is composed of 8 wells each capable of detecting all of the rearrangements of a family V. This assay makes it possible to detect 48 different hIgH V-J rearrangements (therefore observation of 48 rearrangements corresponds to 100% of the observable rearrangements). The PCR conditions are described in the article by Gilles Marodon et al. 2009, supra.

The other materials and methods are identical to those used in example 1 above.

### Results

The quantity of B lymphocytes was investigated previously (Borg et al. 2004), without being identified as a marker of early death in patients with metastatic breast cancer. The correlation between the IgH combinatorial diversity and the occurrence of early death has nevertheless been studied on the same cohort of patients as that described in the preceding example (66 patients).

A univariate analysis of overall survival as a function of IgH divpenia (Table 5) was unable to demonstrate a significant result (p-value >5%).

TABLE 7
univariate analysis of combinatorial diversity
(quantitative and qualitative value) as a function of
overall survival

| REPERTOIRE | HR | SD | P-value |
|---|---|---|---|
| IGH DIVERSITY | 0.988 | 0.009 | 0.180 |
| DIVPENIA IGH <60% | 1.540 | 0.323 | 0.180 |
| DIVPENIA IGH ≧60% | | | |

Despite the results of the univariate analysis, the combinatorial diversity of the IgH chain was integrated in a simple multivariate prediction model (Table 6), as had been done for the study of the TCR (example 1). In this analysis, the diversity threshold was placed at 50% in order to be in the most favorable conditions. With a p-value >5% (P=0.2) the IgH combinatorial diversity does not make it possible to predict early death in metastatic patients.

TABLE 8
multivariate analysis of IgH combinatorial diversity (threshold 50%) as a function of
overall survival

| | | Survival rate | | | | IC lower | IC upper |
|---|---|---|---|---|---|---|---|
| FACTOR | groups | at 14 months | HR | SD | p | 95% | 95% |
| hemoglobin_gp | <11.5 | 28% | 3.609 | 0.363 | 4 × 10⁻⁴ | 1.772 | 7.349 |
| | >=11.5 | 69% | | | | | |
| PNN_gp | <=7.5 | 59% | 1.182 | 0.544 | 0.760 | 0.407 | 3.431 |
| | >7.5 | 43% | | | | | |
| Tumor site Liver | No | 83% | 0.239 | 0.482 | 0.003 | 0.093 | 0.616 |
| | Yes | 49% | | | | | |
| DIVPENIA_IGH | <50% | 38% | 1.849 | 0.478 | 0.200 | 0.725 | 4.717 |
| | >=50% | 59% | | | | | |

### Conclusion

These observations on IgH diversity are valid for the cohort studied, in the model used, and with the version of the technology at the date of the study. In these conditions, the IgH diversity does not make it possible to predict the survival of patients with metastatic breast cancer.

### Example 3

### Comparison of Estimated Costs for a Clinical Trial for Testing an Innovative Treatment for a Solid Cancer, with or without Selection of the Patients According to their Level of Lymphocyte Diversity

Bearing in mind that the procedure for stratification at inclusion is less expensive than the treatment, if out of 100 patients tested by the present method, 15 are at risk, it will be possible to concentrate the clinical study on the 15 patients rather than on the 100 patients. This approach of stratification of the patients most in need of the treatment also makes it possible to increase the chances of success in obtaining a significant p-value relative to a global approach that might in the end lead to a non-significant p-value. (Cf. Table 7 below).

TABLE 9
example of hypotheses of saving made and of improvement
in p-value, following stratification of patients at inclusion in
relation to the measured divpenia

| | | Cost | |
|---|---|---|---|
| Example: | | Example of | Correlation |
| 100 | | average cost | with treatment |
| patients | Number | 10000 [symbol] /patient | efficacy |
| Divpenia | 15 (hypothesis) | 150 K [symbol] | p < 0.005 [symbol] |
| <20% | | | (hypothesis) |
| Divpenia | 85 (hypothesis) | 350 K [symbol] | p > 0.4 |
| >20% | | | (hypothesis) |
| Total | 100 | 1 M [symbol] | p > 0.3 |
| | | | (hypothesis) |

### Example 4

### Analysis of the “Lymphocyte Count/Diversity (LCD)”

Application WO 2009/095567 describes (example 9) a novel counting technique, called “Lymphocyte diversity count”, coupling analysis of the immune repertoire with the patient's lymphocyte count. The results of this count can be represented in a graph that allows several “zones” to be visualized, corresponding to the following situations:

Zone 1. Low count (<1000 Ly/μL) and low combinatorial diversity.
Zone 2. Low count (<1000 Ly/μL) but normal V-J combinatorial diversity.
Zone 3. Normal count (1000-3200 Ly/μL) and low combinatorial diversity.
Zone 4. Normal count (1000-3200 Ly/μL) and normal diversity.

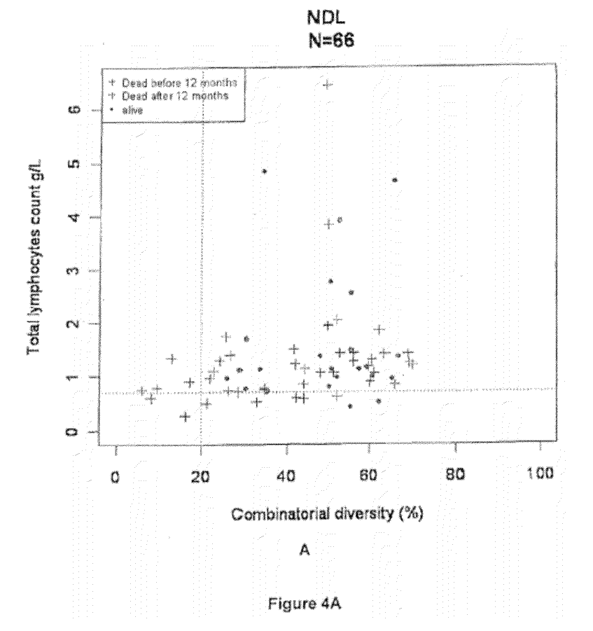

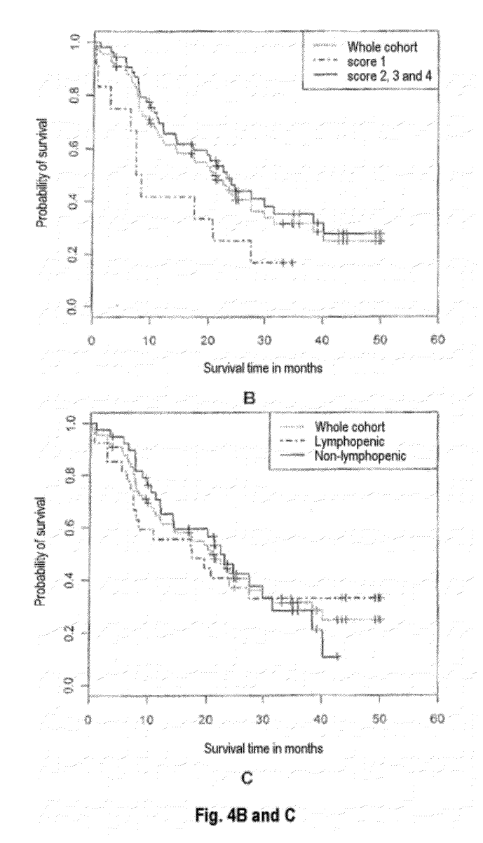

FIG. 4A shows, for the cohort of 66 patients studied in examples 1 and 2 above (designated WP1a), an LDC graph in which the threshold below which the combinatorial diversity is regarded as low was fixed at 30%. FIG. 4B shows, for this same cohort, a survival curve of the patients as a function of their LDC score (corresponding to the zone in which their result is located). FIG. 4C shows, still for the same cohort, the survival curves of the patients depending on whether or not they have lymphopenia (with a threshold at 0.7 Giga/1).

The cohort of WP1b is made up of n=32 patients with breast cancer in first metastatic relapse before any chemotherapy treatment; sampling and the immunological analyses (phenotype and repertoire) were carried out before the chemotherapy treatment.

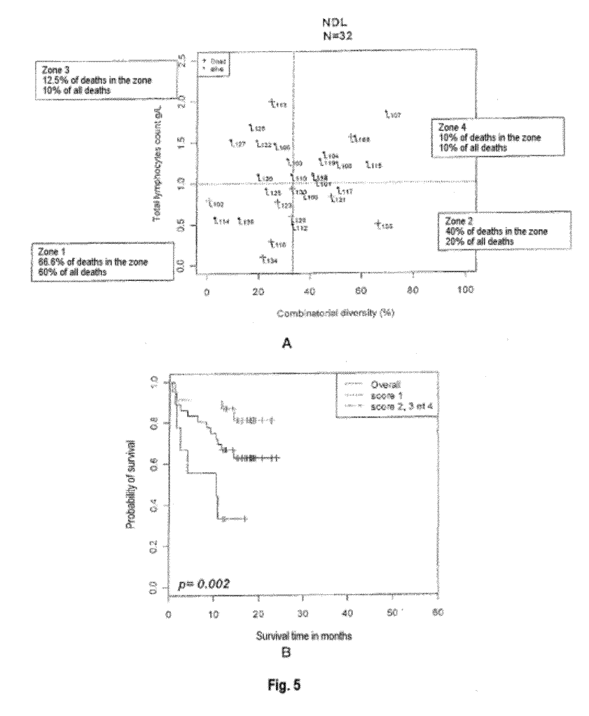

The LDC graph for this cohort is shown in FIG. 5A, and the curve of patients' survival as a function of their LDC score is shown in FIG. 5B.

The LDC graphs obtained from the analyses of the cohorts WP1a (n=66, cohort presented in examples 1 and 2) and WP1b (n=32) show that against all expectation, and contrary to what is generally regarded as obvious, the cell count is not correlated with the diversity. The LDC graphs in FIGS. 4A and 5A show patients with low diversity and a normal count (zone LDC3) and conversely patients with a high diversity and lymphopenia (zone LDC2). This clearly demonstrates that the count is not systematically correlated with the diversity and the quality of the immune repertoire.

NOTE: It is important to point out that, bearing in mind that the immune diversity can vary depending on a treatment, or depending on a disease, the prognostic value of the divpenia marker is only accurate during a certain period of a few days to a few months (concept of time limit of the prediction of infectious risk). It is therefore necessary to perform a 2nd measurement of divpenia or of lymphodivpenia if there is a change in treatment or disease progression, or after a certain period. In fact, in contrast to invariant genetic markers, whether hereditary or not, such as Her2/Neu, mutation p53, deletion of a chromosome arm, prognostic of risk of appearance of a disease and/or of efficacy of a treatment, the immune combinatorial diversity can evolve.

In the retrospective cohort WP1a (n=66), going back about 50 months, the following observations can be made (FIG. 4):
At the combinatorial diversity threshold hTRBV-J=33%, combined analysis of the two parameters (diversity and lymphopenia) makes it possible to characterize the patients most at risk in zone LDC1 (70% of deaths in zone LDC1 and 33% of all deaths).
At a comparable count, zone LDC2 is less at risk than the score LDC1 (lymphopenic) with only 25% of deaths in zone LDC2 and 19% of all deaths of cohort WP1a at 12 months.
Conversely the score LDC4 seems be more “protective” with only 21% of the deaths in the zone and 33% of all the deaths of the cohort.
At a comparable count, the zone with score LDC 3 is more at risk than zone 4 with 40% of deaths in this zone and 10% of all deaths.

“Lymphodivpenia”, i.e. a combination of low lymphocyte diversity and lymphopenia, is therefore a much more powerful marker than each of the two markers considered separately. It is in fact important to note that in this cohort, lymphopenia at the thresholds of 0.7 Giga/L and 1 Giga/L does not appear as a prognostic factor of overall survival, contrary to what was demonstrated in Ray-Coquard et al. (2009) (see FIG. 4C).

In the 2nd prospective cohort WP1b (n=32), going back at least 2 weeks and at most 24 months, the following observations were made:
66% of the lymphodivpenic patients (zone of the score LDC1) died early, which represents 60% of all the deaths in the cohort. The definition of the zone of the score LDC1 corresponds to lymphopenia <1 Giga/L and combinatorial diversity hTRBV-J less than or equal to 33% measured after subtracting the background noise less than or equal to 0.05 UA.
At a comparable count, the zone LDC2 is less at risk than the zone LDC1 (40% of deaths in zone LDC2 and 20% of all deaths).
Conversely the score LDC4 seems be more “protective” with only 10% of the deaths in the zone and 10% of all the deaths of the cohort.
At a comparable count, the zone with score LDC 3 is slightly more at risk than zone 4 with 12.5% of deaths in this zone, constituting 10% of all deaths.

Zones LDC 1 and 2 represent a low lymphocyte level, now a lymphocyte level below 1 Giga/L is poorly prognostic (p=0.0048). Zone LDC 1 which supplies the information on diversity has for its part a better p-value (p=0.002).

### Example 5

### Use of Another Method for Performing the Analysis of the “Lymphocyte Count/Diversity (LCD)”

In order to show that the method described above can be applied using a technology different from the multi-N-plex PCRs for determining patients' lymphocyte diversity, the inventors used the method of high-throughput sequencing described by Robins et al. (Blood, 2009) for measuring the molecular diversity of several samples.

In particular, sequencing was carried out on a sample of PBMC obtained from a healthy subject and on a sample of PBMC in which a clone was diluted (which simulates a sample obtained from a subject with T leukemia); the combinatorial diversities of the two samples were then compared with those obtained by the multi-N-plex technology described above.

The high-throughput sequencing (NGS) was carried out as follows:
Construction of a DNA bank
Obtaining data from sequences performed on the DNA bank
Analysis of the data obtained by sequencing.

In the context of analysis of the immune repertoire, construction of the DNA bank is a key step. This step consists of carrying out multiplex PCRs on the DNA extracted from PBMC. The PCR products thus obtained must be representative of the diversity of the repertoire. In order to minimize the necessary amount of DNA used in these experiments, the PCRs must be performed in a minimum number of tubes. In the course of these PCRs, the adapters necessary for the sequencing step are integrated.

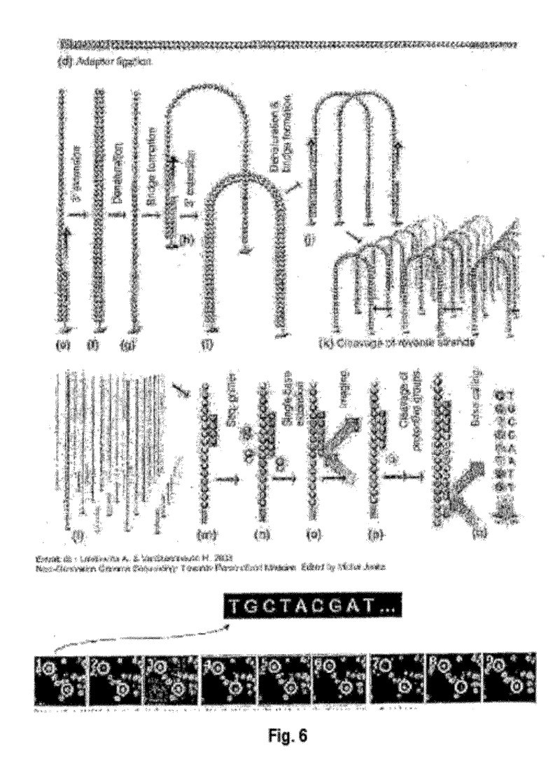

The sequencing proper was carried out according to the technique marketed by the company Illumina (see FIG. 6). The on-chip sequencing is based on the integration of several techniques: DNA biochips, nanotechnology, a variant of the Sanger technique called CRT (cyclic reversible termination), as well as cutting-edge information technology for image acquisition, processing and analysis. The DNA (PCR product in the context of analysis of the immune repertoire) is fixed in the solid phase in cells specially designed for providing fixation of each DNA molecule by means of the adapters. The formation of amplification bridges makes it possible to have a high density of DNA strands. The sequencing principle is based on the reversible incorporation of fluorescent nucleotides and optical reading of the fluorescence. As with the Sanger technique, it is a matter of termination of synthesis based on the use of a reversible terminator containing a protective group attached to the nucleotide that terminates the DNA synthesis. Removal of the protective group by photocleavage using ultraviolet light (>300 nm) permits restoration of the functional group of the incorporated nucleotide, which allows the DNA polymerase to incorporate the next nucleotide, and so on. This is a real-time sequencing, based on detection of the fluorescence but in the presence of the 4 labeled nucleotides. The very high density of the chip (more than 100 million molecules per square centimeter) makes it possible to sequence about 100 000 base pairs per second. Molecules with 54 base pairs are sequenced and then aligned.

The sequence data obtained are analyzed using a clustering algorithm which makes it possible to combine sequences belonging:
To the same gene V
To the same gene J
To the same CDR3
To the same combination of genes V-J
To the same combination V-CDR3-J

So as to be able to compare the results obtained by sequencing with those obtained by the multi-N-plex technology, the data were analyzed only taking into account the combination gene family V and gene J.

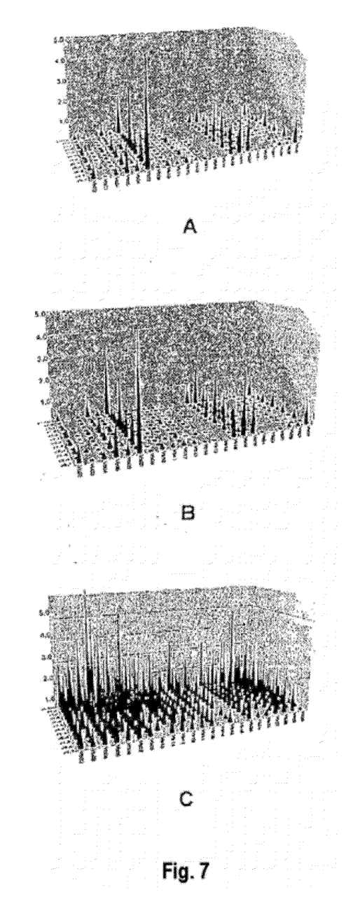

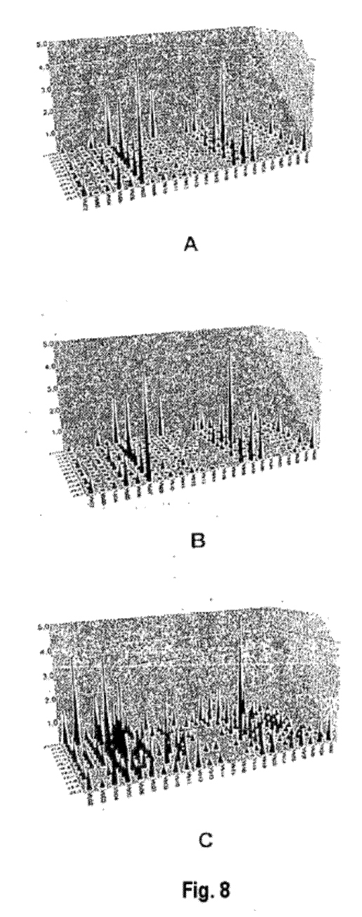

The results obtained are presented in FIGS. 7 and 8.

FIGS. 7A and 7B correspond to the sample of PBMC from a healthy subject, processed by sequencing in duplicate, which gives diversities of 69.9% and 73.6%, whereas measurement by the multi-N-plex technology gives a result of 84.4% (FIG. 7C).

FIGS. 8A and 8B correspond to the sample mimicking PBMCs from a leukemic subject, processed by sequencing in duplicate, which gives diversities of 68.8% and 67.8%, whereas measurement by the multi-N-plex technology gives a result of 62.68% (FIG. 8C).

By reproducing these experiments on a larger number of samples, a person skilled in the art can without difficulty “calibrate” an alternative technology (such as the high-throughput sequencing illustrated here) for carrying out the invention without using the multi-N-plex PCRs.

### REFERENCES

Baum, P. D. and McCune, J. M. (2006) Direct measurement of T-cell receptor repertoire diversity with AmpliCot. Nat Methods, 3, 895-901.
Bogue, M., Gilfillan, S., Benoist, C. and Mathis, D. (1992) Regulation of N-region diversity in antigen receptors through thymocyte differentiation and thymus ontogeny. Proc Natl Acad Sci USA, 89, 11011-11015.
Bonarius, H. P., Baas, F., Remmerswaal, E. B., van Lier, R. A., ten Berge, I. J., Tak, P. P. and de Vries, N. (2006) Monitoring the T-cell receptor repertoire at single-clone resolution. PLoS ONE, 1, e55.
Borg, C., Ray-Coquard, I., Philip, I., Clapisson, G., Bendriss-Vermare, N., Menetrier-Caux, C., Sebban, C., Biron, P. and Blay, J. Y. (2004) CD4 lymphopenia as a risk factor for febrile neutropenia and early death after cytotoxic chemotherapy in adult patients with cancer. Cancer, 101, 2675-2680.
Chaudhuri, J., Tian, M., Khuong, C., Chua, K., Pinaud, E. and Alt, F. W. (2003) Transcription-targeted DNA deamination by the AID antibody diversification enzyme. Nature, 422, 726-730.
Cochet, M., Pannetier, C., Regnault, A., Datche, S., Leclerc, C. and Kourilsky, P. (1992) Molecular detection and in vivo analysis of the specific T cell response to a protein antigen, Eur J Immunol, 22, 2639-2647.
Cox D. R. (1972) Regression model and life rables. J Roy Stat Soc, 34, 187-220.
Davis, M. M. and Bjorkman, P. J. (1988) T-cell antigen receptor genes and T-cell recognition. Nature, 334, 395-402.
Douek, D. C., McFarland, R. D., Keiser, P. H., Gage, B. A., Massey, J. M., Haynes, B. F., Polis, M. A., Haase, A. T., Feinberg, M. B., Sullivan, J. L., Jamieson, B. D., Zack, J. A., Picker, L. J. and Koup, R. A. (1998) Changes in thymic function with age and during the treatment of HIV infection. Nature, 396, 690-695.
Fugmann, S. D., Lee, A. I., Shockett, P. E., Villey, I. J. and Schatz, D. G. (2000) The RAG proteins and V(D)J recombination: complexes, ends, and transposition. Annu Rev Immunol, 18, 495-527.
Fuschiotti, P., Pasqual, N., Hierle, V., Borel, E., London, J., Marche, P. N. and Jouvin-Marche, E. (2007) Analysis of the TCR alpha-chain rearrangement profile in human T lymphocytes. Mol Immunol, 44, 3380-3388.
Hamblin T. J., Davis, Z., Gardiner, A., Oscier, D. G. and Stevenson, F. K. (1999) Unmutated Ig V(H) genes are associated with a more aggressive form of chronic lymphocytic leukemia. Blood, 94, 1848-1854.
Kaplan, E. L. and Meier, P. (1958) Non parametric estimation from incomplete observations. J Am Stat Assoc, 53, 457-481.
Kotani, A., Okazaki, I. M., Muramatsu, M., Kinoshita, K., Begum, N. A., Nakajima, T., Saito, H. and Honjo, T. (2005) A target selection of somatic hypermutations is regulated similarly between T and B cells upon activation-induced cytidine deaminase expression. Proc Natl Acad Sci USA, 102, 4506-4511.
Marodon, G., Desjardins, D., Mercey, Baillou, C., Parent, P., Manuel, M., Caux, C., Bellier, B, Pasqual, N. and Klatzmann, D. (2009) High diversity of the immune repertoire in humanized NOD.SCID.gamma c−/− mice. Eur J Immunol, 39, 2136-2145.
Pannetier, C., Even, L and Kouritsky, P. (1995) T-cell repertoire diversity and clonal expansions in normal and clinical samples. Immunol Today, 16, 176-181.
Pasqual, N., Gallagher, M., Aude-Garcia, C., Loiodice, M., Thuderoz, F., Demongeot, J., Ceredig, R., Marche, P. N. and Jouvin-Marche, E. (2002) Quantitative and qualitative changes in V-J alpha rearrangements during mouse thymocytes differentiation: implication for a limited T cell receptor alpha chain repertoire. J Exp Med, 196, 1163-1173.
Pham, T., Belzer, M., Church, J. A., Kitchen, C., Wilson, C. M., Douglas, S. D., Geng, Y., Silva, M., Mitchell, R. M. and Krogstad, P. (2003) Assessment of thymic activity in human immunodeficiency virus-negative and -positive adolescents by real-time PCR quantitation of T-cell receptor rearrangement excision circles. Clin Diagn Lab Immunol, 10, 323-328.
Ray-Coquard, I., Cropet, C., Van Glabbeke, M., Sebban, C., Le Cesne, A., Judson, I., Tredan, O., Verweij, J., Biron, P., Labidi, I. Guastalla, J. P., Bachelot, T., Perol, D., Chabaud, S., Hogendoorn, P. C., Cassier, P., Dufresne, A. and Blay, J. Y. (2009) Lymphopenia as a prognostic factor for overall survival in advanced carcinomas, sarcomas, and lymphomas. Cancer Res, 69, 5383-5391.
Robins, H. S., Campregher, P. V., Srivastava, S. K. Wacher, A., Turtle, C. J., Kahsai, O., Riddell, S. R. Warren, B. H. and Carlson, C. S. (2009) Comprehensive assessment of T-cell receptor beta-chain diversity in alphabeta T cells. Blood, 114, 4099-4107.
Rothman, K. J. (1978) Estimation of confidence limits for the cumulative probability of survival in life table analysis. J Chronic Dis, 31, 557-560.
Themeau, T. M. and Grambsch, P. M. (2000) Modeling, survival data. extending the Cox Model. Statistics for biology and health, Springer Ed. Mayo Foundation, New York.
Van den Beemd, van Dongen et al. (2000), “Flow cytometric detection of clonality in mature T-cell malignancies by use of a Vb antibody kit”, ISAC Abstract.

1. A method for establishing ex vivo or in vitro a prognosis for an individual who has a metastatic solid cancer, comprising the following steps:
(i) measuring the level of diversity of the T-lymphocyte repertoire from nucleic acid derived from a biological sample containing lymphocytes of said individual; and
(ii) comparing the level of diversity measured in step (i) with a predetermined threshold;
wherein if the level of diversity measured in step (i) is below the predetermined threshold, the individual has a high risk of early death.

2. The method as claimed in claim 1, wherein the cancer from which the individual is suffering is a breast cancer.

3. The method as claimed in claim 1, wherein, in step (i), the nucleic acid used is genomic DNA.

4. The method as claimed in claim 1, wherein, in step (i), the combinatorial diversity of the T-lymphocyte repertoire is measured.

5. The method as claimed in claim 4, wherein measurement of the combinatorial diversity of the T-lymphocyte repertoire of said individual is carried out by a method analyzing at least 10 V(D)J rearrangements of the TRA locus or of the TRB locus.

6. The method as claimed in claim 5, wherein measurement of the combinatorial diversity of the T-lymphocyte repertoire of said individual is carried out by a method analyzing at least 20 V(D)J rearrangements of the TRA locus or of the TRB locus.

7. The method as claimed in claim 5, wherein measurement of the combinatorial diversity of the T-lymphocyte repertoire of said individual is carried out by a method analyzing at least 70% of the V(D)J rearrangements of the TRB locus.

8. The method as claimed in claim 5, wherein measurement of the combinatorial diversity of the T-lymphocyte repertoire is carried out by multi-n-plex PCRs with n≧2 by means of combinations of at least 3 primers, each combination of primers comprising at least the primers hTRBJ1.6 (SEQ ID No: 1), hTRBJ2.7 (SEQ ID No: 2) and a primer hTRBV selected from the group consisting of the primers of SEQ ID No: 3 to 25.

9. The method as claimed in claim 8, wherein the analysis is performed by carrying out at least 23 multi-2-plex PCRs, each multi-2-plex PCR being carried out with a triplet of primers consisting of the primers hTRBJ1.6 (SEQ ID No: 1), hTRBJ2.7 (SEQ ID No: 2) and a primer hTRBV selected from the group consisting of the primers of SEQ ID No: 3 to 25.

10. The method as claimed in claim 1, wherein the biological sample is a sample of a tissue selected from blood, white blood cells (PBMC), thymus, a lymph node, spleen, breast, liver, skin, a tumor sample or a biological fluid (pleural effusion, ascites).

11. The method as claimed in claim 1, wherein the biological sample is a sample of whole blood or of PBMC.

12. The method as claimed in claim 1, wherein in step (i), the genomic DNA is purified from the biological sample.

13. The method as claimed in claim 1, wherein the threshold used in step (ii) is such that the expected survival of a patient for whom the level of diversity measured in step (i) is below this threshold is at least half the expected survival generally observed for patients with the same metastatic solid cancer as that affecting the patient.

14. The method as claimed in claim 1, wherein in step (ii), the threshold is fixed at 30% diversity, and the interpretation in step (iii) consists of saying that if the measured level of T-lymphocyte combinatorial diversity is below said threshold, the individual has a life expectancy half that generally observed for his/her pathology.

15. The method as claimed in claim 1, wherein in step (ii), the threshold is fixed at 20% diversity, and the interpretation in step (iii) consists of saying that if the measured level of T-lymphocyte combinatorial diversity is below said threshold, the individual has a life expectancy from two to five times less than that generally observed for his/her pathology.

16. The method as claimed in claim 1, wherein the patient has metastatic breast cancer, and wherein a level of diversity of the V(D)J rearrangements of the TRB locus of less than 20% is indicative of an expected survival of the patient of less than 6 months.

17. The method as claimed in claim 1, wherein the prognosis is established by combining the level of diversity of the T-lymphocyte repertoire of said individual with his/her lymphocyte count.

18. The method as claimed in claim 1, wherein the prognosis is established by combining the level of diversity measured in step (i), with one or more other biological or clinical parameters selected from the lymphocyte count, CD4+ cell count, serum cytokine level, PS (performance status) and hemoglobin level.

19. A method for determining ex vivo or in vitro whether a patient with a solid cancer should be included in a protocol of clinical research for testing a new medicinal product, comprising the following steps:
(i) determining, by employing the method as claimed in claim 1, whether the patient has an increased risk of early death, and
(ii) if the patient has an increased risk of early death, including the patient in the protocol of clinical research.

20. (canceled)


SEQUENCE LISTING (25 sequences)

SEQ ID NO: 1 - DNA, 25 bp, Artificial
  amorce
cttggtgcatggctatgtaatcctg

SEQ ID NO: 2 - DNA, 22 bp, Artificial
  amorce
ctcgccctctgctcagctttcc

SEQ ID NO: 3 - DNA, 26 bp, Artificial
  amorce
cacacagatgggacaggaagtgatct

SEQ ID NO: 4 - DNA, 23 bp, Artificial
  amorce
gcttctcacctgaatgccccaac

SEQ ID NO: 5 - DNA, 25 bp, Artificial
  amorce
ctgatcaaaacgagaggacagcaag

SEQ ID NO: 6 - DNA, 25 bp, Artificial
  amorce
ctgatcaaaacgagaggacagcacg

SEQ ID NO: 7 - DNA, 23 bp, Artificial
  amorce
gatcacccaggcaccaacatctc

SEQ ID NO: 8 - DNA, 25 bp, Artificial
  amorce
cagatcacacaggagctggagtctc

SEQ ID NO: 9 - DNA, 27 bp, Artificial
  amorce
cacagatcacgcagatactggagtctc

SEQ ID NO: 10 - DNA, 23 bp, Artificial
  amorce
cgcacaacagttccctgacttgc

SEQ ID NO: 11 - DNA, 27 bp, Artificial
  amorce
ttcacagttgcctaaggatcgattttc

SEQ ID NO: 12 - DNA, 27 bp, Artificial
  amorce
ttctctggtacagacagacctttgtgc

SEQ ID NO: 13 - DNA, 27 bp, Artificial
  amorce
ttttctggtacagagataccttcgtgc

SEQ ID NO: 14 - DNA, 25 bp, Artificial
  amorce
gttgctgaagtgtcaaactctcccg

SEQ ID NO: 15 - DNA, 24 bp, Artificial
  amorce
tccccagccacagcgtaatagaga

SEQ ID NO: 16 - DNA, 24 bp, Artificial
  amorce
ccccaaagctgctgttccactact

SEQ ID NO: 17 - DNA, 22 bp, Artificial
  amorce
ctcctggtgaagaagtcgccca

SEQ ID NO: 18 - DNA, 22 bp, Artificial
  amorce
tagtgcgaggagattcggcagc

SEQ ID NO: 19 - DNA, 23 bp, Artificial
  amorce
ctgggagcaagtgagtcctgggt

SEQ ID NO: 20 - DNA, 24 bp, Artificial
  amorce
tcatcaaccatgcaagcctgacct

SEQ ID NO: 21 - DNA, 24 bp, Artificial
  amorce
agtgtctctcgacaggcacaggct

SEQ ID NO: 22 - DNA, 23 bp, Artificial
  amorce
cctctttgttgggtttgtgcctg

SEQ ID NO: 23 - DNA, 22 bp, Artificial
  amorce
gtccccttcctttacaggcccc

SEQ ID NO: 24 - DNA, 21 bp, Artificial
  amorce
ccatcagccgcccaaacctaa

SEQ ID NO: 25 - DNA, 26 bp, Artificial
  amorce
tgctcttctactccgttggtattggc